(19) United States
(12) Patent Application Publication
(10) Pub. No.: US 2008/0105163 A1
(43) Pub. Date: May 8, 2008

(54) Sol-gel method for producing low reflection film

(75) Inventors: Chin-Wei Lu, Chung-Li City (TW); Yua-Kuang Chen, Chung-Li City (TW)

Correspondence Address: BANNER & WITCOFF, LTD., 1100 13th STREET, N.W., SUITE 1200, WASHINGTON, DC, 20005-4051, US

(73) Assignee: FAR EASTERN TEXTILE LTD., Taipei (TW)

(21) Appl. No.: 11/746,350

(22) Filed: May 9, 2007

(30) Foreign Application Priority Data
Nov. 6, 2006 (TW) 095140967

(51) Int. Cl. C09K 19/02

(52) U.S. Cl. 106/287.1; 106/287.17

(57) ABSTRACT

A sol-gel method for producing a coating solution for a low reflection film includes: preparing a liquid reaction mixture containing a silicon compound; and allowing the liquid reaction mixture to undergo hydrolysis and condensation in the presence of a solid catalyst so as to form the coating solution. A method for producing a low reflection film includes: preparing a liquid reaction mixture containing a silicon compound; allowing the liquid reaction mixture to undergo hydrolysis and condensation in the presence of a solid catalyst so as to form a coating solution; removing the solid catalyst from the coating solution; applying the coating solution to a substrate; and drying the coating solution on the substrate.

### CROSS-REFERENCE TO RELATED APPLICATION

This application claims priority of Taiwanese application no. 095140967, filed on Nov. 6, 2006.

### BACKGROUND OF THE INVENTION

1. Field of the Invention

This invention relates to a sol-gel method for producing a coating solution for a low reflection film.

2. Description of the Related Art

Displays, such as conventional cathode ray tubes (CRTs), liquid crystal displays (LCDs), and plasma display panels (PDPs), can be used in various environments. When the display is exposed to a relatively bright ambient, such as the outdoors, a reflection problem on the display is likely to occur, which results in an adverse effect on the image quality of the display. To prevent the undesired reflection problem and to improve image quality, an anti-reflection film (0 to 1% of reflectance) or a low reflection film (1 to 2% of reflectance) is used. In consideration of the cost, the anti-reflection film having a higher manufacturing cost as compared to the low reflection film is usually used in a small size display (e.g., the display of a portable computer), whereas the low reflection film is usually used in a large size display.

At present, the low reflection film is made using a sol-gel technique which employs a reaction mixture containing a silicon compound, such as an alkoxysilane compound (e.g., tetraethoxysilane (TEOS), methyltriethoxysilane (MTEOS), etc.), as a reactant. In the process, a strong acid (e.g., hydrochloride) or a strong alkali (e.g., ammonia) is dissolved in the reaction mixture to provide a suitable environment (i.e., pH<2 or pH>10) to allow the reaction mixture to undergo hydrolysis and condensation reactions.

In the sol-gel process, the pH value is an important factor for the hydrolysis and condensation reactions. If the pH value is in a range from 4 to 7, undesired rapid condensation and premature agglomeration of sol are likely to occur, such that the size of the sol is too large to be evenly and suitably coated on a substrate. Therefore, the pH value should be maintained in the above suitable range. However, under the strong acid or alkali environment, severe corrosion to apparatus employed for producing the coating solution occurs, and the service life of the apparatus is considerably shortened, thereby resulting in high manufacturing costs. Moreover, strong acid and strong alkali solutions are inconvenient to store and incur safety concerns.

### SUMMARY OF THE INVENTION

Therefore, the object of the present invention is to provide a sol-gel method for producing a coating solution for a low reflection film, and a method for producing a low reflection film, which can overcome the aforesaid drawbacks of the prior art.

According to one aspect of this invention, a sol-gel method for producing a coating solution for a low reflection film includes: preparing a liquid reaction mixture containing a silicon compound; and allowing the liquid reaction mixture to undergo hydrolysis and condensation in the presence of a solid catalyst so as to form the coating solution.

According to another aspect of this invention, a method for producing a low reflection film includes: preparing a liquid reaction mixture containing a silicon compound; allowing the liquid reaction mixture to undergo hydrolysis and condensation in the presence of a solid catalyst so as to form a coating solution; removing the solid catalyst from the coating solution; applying the coating solution to a substrate; and drying the coating solution on the substrate.

### DETAILED DESCRIPTION OF THE PREFERRED EMBODIMENTS

The preferred embodiment of a sol-gel method for producing a coating solution for a low reflection film according to this invention includes: preparing a liquid reaction mixture containing a silicon compound; and allowing the liquid reaction mixture to undergo hydrolysis and condensation in the presence of a solid catalyst so as to form the coating solution.

In this invention, the catalyst used is a solid acidic or alkaline catalyst which is undissolvable in the liquid reaction mixture. Although the pH value of the liquid reaction mixture is influenced by the added amount of the solid acidic or alkaline catalyst, i.e., the mixture is converted from a neutral state into an acidic state or an alkaline state, after removing the solid catalyst from the liquid reaction mixture, the pH value of the liquid reaction mixture is returned to the neutral state. This is because the solid catalyst with strong acidity or alkalinity merely affects the surrounding liquid reaction mixture, rather than the entire liquid reaction mixture. For example, the solution closer to the alkaline solid catalyst has a higher alkaline pH value. In addition, it is found that even though the pH value of the liquid reaction mixture is in a range of 4 to 5 (weak acidity) or 9 to 10 (weak alkalinity) after dispersing the solid catalyst in the liquid reaction mixture, the hydrolysis and condensation reactions still proceed effectively without causing the aforesaid undesired rapid condensation and premature agglomeration problems as encountered in the prior art.

Preferably, the solid catalyst is in the form of porous powders. As such, the pH value of the reaction mixture in pores in the porous catalyst powders has a stronger acidity or stronger alkalinity than the rest of the reaction mixture so as to provide a suitable environment for hydrolysis and condensation reactions. Suitable porous catalysts are, for example, acidic and alkaline aluminum oxide powders manufactured by ACROS company and having a particle size ranging from 50 to 200 μm. A pH value of 4.0 or 9.5 can be achieved by dispersing 5 wt % acidic aluminum oxide or 5 wt % alkaline aluminum oxide in water. Preferably, the solid catalyst is present in an amount ranging from 1 to 20 wt % of the liquid reaction mixture so as to provide a suitable reaction environment.

After finishing the reactions, the coating solution is diluted with a co-solvent, followed by removal of the solid catalyst. Alternatively, the solid catalyst can be firstly removed, followed by dilution of the coating solution with a co-solvent. After removal of the solid catalyst and dilution of the coating solution with the co-solvent, the solid content of the coating solution should be less than 10 wt % so as to prevent sol agglomeration. In addition, the removed solid catalyst can be reused.

The silicon compound suitable for this invention is one generally used for manufacturing the low reflection film and expressed by formula R¹Si(R²)₃, in which R¹ is an alkoxy group, a functional alkyl chain, or a perfluoroalkyl group, and in which R² is a hydrolysable group, such as halogen or C₁-C₅ alkoxy group. Preferably, the silicon compound includes tetraethoxysilane, tridecafluorooctyltriethoxysilane, tetramethoxysilane, methyltriethoxysilane, propyltrimethoxysilane, tetraisopropoxysilane, and 3-methacryloxypropyltrimethoxysilane. Since the silicon compound is undissolvable in water, isopropanol and ethanol can be used as a co-solvent for dissolving the silicon so as to form the liquid reaction mixture.

This invention also provides a method for producing a low reflection film using the sol-gel method of this invention. The method for producing a low reflection film includes: preparing the aforesaid coating solution according to the sol-gel method of this invention; removing the solid catalyst powders from the coating solution; applying the coating solution to a substrate; and drying the coating solution on the substrate.

Preferably, the step for applying the coating solution to the substrate can be performed using wire coating, spin coating, or dip coating techniques. The substrate can be made from triacetate cellulose (TAC), poly(ethylene terephthalate) (PET), polycarbonate (PC), poly(ethylene naphthalate) (PEN), etc. The refractive index of the substrate is preferably greater than 1.48. The drying temperature in the drying step is required to be less than the deforming temperature of the substrate. The low reflection film thus formed on the substrate has a refractive index ranging from 1.35 to 1.45, which is lower than the refractive index of the substrate.

The merits of the method of this invention will become apparent with reference to the following examples and comparative examples.

### EXAMPLE

### Example 1

13 g acidic aluminum oxide (manufactured by ACROS company) serving as the solid catalyst was dispersed in 50 g pure water. The pH value of the mixture was about 4-5.80 g isopropanol (manufactured by TEDIA company and used as a co-solvent), 50 g tetraethoxysilane (manufactured by Shin-Etsu company), and 30 g tridecafluorooctyltriethoxysilane (manufactured by Degussa company) were added into the mixture so as to form a reaction solution. A coating solution was obtained by heating and stirring the reaction solution at 70° C. for 12 hrs. After cooling to the ambient temperature, the coating solution was diluted with 1890 g of a co-solvent containing isopropanol and butanol at a weight ratio of 6:4 such that the solid content of the coating solution was reduced to 2 wt %. The solid catalyst was then removed using a 5 μm filtering paper. The coating solution thus formed was coated on a substrate (manufactured by TOYOBO-A4100 company, and having an A4 size and a 1.65 refractive index) using wire coating techniques to form a 5 μm coating layer, followed by drying in an oven at 110° C. for 5 min to form a 0.1 μm coating layer on the substrate. The film thus formed has a reflectance of about 1.3% measured at a 5-degree angle under 400-700 nm, and can be used as a low reflection film.

### Example 2

The method in this example is similar to that of the previous example, except that the solid catalyst employed in this example was recycled from Example 1. The film thus formed has a reflectance of about 1.3%, and can be used as a low reflection film. The result shows that the recycled catalyst also has an effective catalysis function.

### Example 3

4.08 g alkaline aluminum oxide (manufactured by ACROS company) serving as the solid catalyst was dispersed in 17.77 g pure water. The pH value of the mixture was about 9-10.157 g isopropanol (manufactured by TEDIA company and used as a co-solvent), 20.5 g tetraethoxysilane (manufactured by Shin-Etsu company), and 2.5 g tridecafluorooctyltriethoxysilane (manufactured by Degussa company) were added into the mixture so as to form a reaction solution. A coating solution was obtained by heating and stirring the reaction solution at 60° C. for 60 hrs. After cooling to the ambient temperature, the coating solution was diluted with 400 g of a co-solvent containing isopropanol and butanol at a weight ratio of 6:4, such that the solid content of the coating solution was reduced to 2 wt %. The solid catalyst was then removed using a 5 μm filtering paper. The processes for applying the coating solution to a substrate and for drying the film on the substrate were the same as those of Example 1. The film thus formed has a reflectance of about 1.7%, and can be used as a low reflection film.

### Example 4

2.44 g alkaline aluminum oxide (manufactured by ACROS company) serving as the solid catalyst was dispersed in 3.9 g pure water. The pH value of the mixture was about 10.157 g isopropanol (manufactured by TEDIA company and used as a co-solvent) and 20.5 g tetraethoxysilane (manufactured by Shin-Etsu company) were added into the mixture so as to form a reaction solution. A coating solution was obtained by heating and stirring the reaction solution at 60° C. for 16 hrs. After cooling to the ambient temperature, the coating solution was diluted with 350 g of a co-solvent containing isopropanol and butanol at a weight ratio of 6:4, such that the solid content of the coating solution was reduced to 2 wt %. The solid catalyst was then removed using a 5 μm filtering paper. The processes for applying the coating solution to a substrate and for drying the film on the substrate were the same as those of Example 1. The film thus formed has a reflectance of about 1.7%, and can be used as a low reflection film.

### Comparative Example 1

0.1 M hydrochloride solution serving as the liquid catalyst was added to 50 g pure water. The pH value of the mixture was about 4-5.50 g tetraethoxysilane (manufactured by Shin-Etsu company) and 30 g tridecafluorooctyltriethoxysilane (manufactured by Degussa company) were added into the mixture so as to form a reaction solution. A coating solution was obtained by heating and stirring the reaction solution at 70° C. for 6 hrs. During reaction, undesired rapid condensation and premature agglomeration occurred. The coating solution thus formed was turbid and in white color after cooling. The processes for applying the coating solution to a substrate and drying the film on the substrate were the same as those of Example 1. The sol thus obtained in this comparative example could not form an even and transparent film on the substrate.

With the use of the solid catalyst in the sol-gel method of the present invention, the aforesaid corrosion problem can be considerably alleviated as a result of a much lower acidity or alkalinity of the reaction mixture of this invention as compared to that of the reaction mixture containing the liquid acidic or alkaline catalyst in the prior art. Moreover, the solid catalyst can be recycled and reused, so that manufacturing costs can be reduced. In addition, since the solid catalyst is easily stored and operated, safety concerns are alleviated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A sol-gel method for producing a coating solution for a low reflection film, comprising:
preparing a liquid reaction mixture containing a silicon compound; and
allowing the liquid reaction mixture to undergo hydrolysis and condensation in the presence of a solid catalyst so as to form the coating solution.

2. The sol-gel method of claim 1, wherein the solid catalyst is in the form of porous powders.

3. The sol-gel method of claim 1, wherein the solid catalyst is acidic aluminum oxide.

4. The sol-gel method of claim 1, wherein the solid catalyst is alkaline aluminum oxide.

5. The sol-gel method of claim 1, wherein the solid catalyst is present in an amount ranging from 1 to 20 wt % of the liquid reaction mixture.

6. A method for producing a low reflection film, comprising:
preparing a liquid reaction mixture containing a silicon compound;
allowing the liquid reaction mixture to undergo hydrolysis and condensation in the presence of a solid catalyst so as to form a coating solution;
removing the solid catalyst from the coating solution;
applying the coating solution to a substrate; and
drying the coating solution on the substrate.

7. The method of claim 6, wherein the solid catalyst is in the form of porous powders.

8. The method of claim 6, wherein the solid catalyst is acidic aluminum oxide.

9. The method of claim 6, wherein the solid catalyst is alkaline aluminum oxide.

10. The method of claim 6, wherein the solid catalyst is present in an amount ranging from 1 to 20 wt % of the liquid reaction mixture.
